(19) United States
(12) Patent Application Publication
(10) Pub. No.: US 2025/0390844 A1
(43) Pub. Date: Dec. 25, 2025

(54) INTELLIGENT GENERATION OF A TASK LIST BASED ON DATA OBTAINED FROM DIFFERENT DOMAINS

(71) Applicant: Rothbright Inc., Edgewater, CO (US)

(72) Inventors: Daniel Harris PATTON, Edgewater, CO (US); Marcus Leonard FRYE, Las Vegas, NV (US); Shashank Tulshiram DATE, Overland Park, KS (US); William Alexander JAY, Edgewater, CO (US)

(21) Appl. No.: 19/236,181

(22) Filed: Jun. 12, 2025

Related U.S. Application Data
(60) Provisional application No. 63/662,056, filed on Jun. 20, 2024.
(60) Provisional application No. 63/703,720, filed on Oct. 4, 2024.

(51) Int. Cl. G06Q 10/10; G06F 40/30

(52) U.S. Cl. CPC G06Q 10/103; G06F 40/30

(57) ABSTRACT

Techniques for formatting unstructured data into a structured task list are disclosed. A service accesses a first source that includes a set of structured data. The service accesses a second source that includes a set of unstructured data. The service accesses task structuring rules that govern how one or more tasks are to be formatted. The service generates a prompt for a machine learning (ML) predictive model. The prompt includes the structured data, the unstructured data, and the task structuring rules. The prompt further includes a directive to generate tasks worded in accordance with the task structuring rules based on the structured and unstructured data. In response to the ML predictive model generating the tasks, the service determines a sequential ordering for the tasks. The service displays the tasks in a user interface in accordance with the sequential ordering.

### CROSS-REFERENCE TO RELATED APPLICATIONS

This application claims the benefit of and priority to U.S. Provisional Patent Application Ser. No. 63/662,056 filed on Jun. 20, 2024 and entitled “INTELLIGENT GENERATION OF A TASK LIST BASED ON DATA OBTAINED FROM DIFFERENT DOMAINS,” which application is expressly incorporated herein by reference in its entirety. This application also claims the benefit of and priority to U.S. Provisional Patent Application Ser. No. 63/703,720 filed on Oct. 4, 2024 and entitled “INTELLIGENT GENERATION OF A TASK LIST BASED ON DATA OBTAINED FROM DIFFERENT DOMAINS,” which application is expressly incorporated herein by reference in its entirety.

### BACKGROUND

The development of software involves many different phases. As various examples, these phases often include a planning phase, a development phase, a deployment phase, and a subsequent management and update phase. Throughout these various different phases, it is often desirable to provide an insightful and helpful digital experience for the developers and eventual users of the software. In scenarios, these phases might involve multiple different clients or multiple different users. Thus, it is often the case that software development and management is performed in a multi-client environment, where the “client” can be any type of entity, such as developers, managers, or even customers.

It is becoming increasingly challenging to keep track of all of the incoming requests and services that a client is demanding. For instance, consider a scenario where an enterprise provides an email for receiving feedback from customers. It will often be the case that this email will explode with a large number of emails from the customers requesting various updates or changes to a software application. In another scenario, feedback can be received using other platforms, such as via text messages or online chat boards. Thus, feedback can be received through a plethora of different communication channels.

When a change is to be made to a software application, the typical process often involves a quote and a request. For instance, suppose a new request is received by a group of developers. To incorporate this request, it is often the case that the developers will need to obtain permission to work on the order. The developers will thus submit a quote describing the work and describing how much billable time the request will likely take. This quote will be reviewed and either approved or denied. If approved, the developers can then work on the request.

In today's world, it has been observed that in this field, it is often the case that machines or external third party systems drive the request vector as opposed to a human requester. As an example, consider an analytics program that tracks and monitors an asset (e.g., a website or an application). This analytics program can monitor the asset and may determine that a number of updates are needed for the asset. What often happens is that the analytics program will detect these update deficiencies and will then trigger a notification to an entity who is suspected of being the responsible party for the asset. Often, however, this entity does not receive the notification or simply ignores the notification. The consequence is that the updates to the asset are often ignored.

Ignoring these updates can have a significant impact on the asset, however. As an example, consider a scenario where the asset is a software application that numerous clients are using. It may be the case that this software application is scheduled to be transitioned to a new platform, and action is required on the part of the client to facilitate this transfer. If that action is not performed, the client is notified that they will lose their data. One will appreciate how it is highly important for the client to take this action so as to not lose their data. If that notification were ignored, however, then potentially catastrophic results may occur. Similar disruptions can occur on the developer's side if notifications are missed or ignored.

As another example, consider a scenario where the asset is an application that involves government regulatory action. Further suppose a new regulation is released by the government. To remain compliant, the application may be required to undergo a specific modification. If the entity responsible for the application did not properly respond to the new regulation, then the application may no longer be compliant and may result in legal action. Thus, from these examples, one can observe how it is desirable to monitor and manage notifications, but it is also easy to observe how those notifications may “fly under the radar” and may be missed. Consequently, it is often the case that with technical notifications, those notifications often have a prematurely short life cycle because they are not properly managed and dealt with because those notifications are not viewed as being actionable. This situation arises because of failures involving the communication vector for those notifications, which may involve multiple actors.

Stated differently, situations arise in which multiple different actors are interacting with one another, such as a scenario involving a client and a developer. These situations often involve multiple events that have to transpire for a given asset and that may end up being a disruptive, breaking event if not properly managed. Due to failures in the communication vectors and due to deficiencies in other communication techniques, it is often the case that these events are not able to properly be done or are not being routed to those individuals who have the capability to address those events.

In addition to the communication vectors, multiple other vectors are also involved, such as a timing vector or a price vector. Often, events are not performed in a timely manner or in a costly manner. The result of not timely performing these actions is that developing entities are paving the way for liability holes, security holes, profit holes, operational holes, and productivity holes. These issues expand as scale is increased. Thus, an artificial ceiling is often imposed on development processes because they lack optimization. What is needed, therefore, is an improved technique for managing the communication vectors for events of any kind, including software events.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a method including: accessing a first source associated with a first domain, wherein the first source includes a set of structured data; accessing a second source associated with a second domain, wherein the second source includes a set of unstructured data; accessing a set of task structuring rules that govern how one or more tasks are to be formatted; generating a prompt for a machine learning (ML) predictive model, the prompt including the set of structured data, the set of unstructured data, and the set of task structuring rules, wherein the prompt further includes a directive to generate a plurality of tasks worded in accordance with the set of task structuring rules, where the plurality of tasks is generated based on the set of structured data and the set of unstructured data; in response to the ML predictive model generating the plurality of tasks, determining a sequential ordering for the plurality of tasks; and displaying the plurality of tasks in a user interface in accordance with the sequential ordering.

In some aspects, the techniques described herein relate to a computer system including: a processor system; and a storage system that stores instructions that are executable by the processor system to cause the computer system to: access a first source associated with a first domain, wherein the first source includes a set of structured data; access a second source associated with a second domain, wherein the second source includes a set of unstructured data; access a set of task structuring rules that govern how one or more tasks are to be formatted; generate a prompt for a machine learning (ML) predictive model, the prompt including the set of structured data, the set of unstructured data, and the set of task structuring rules, wherein the prompt further includes a directive to generate a plurality of tasks worded in accordance with the set of task structuring rules, where the plurality of tasks is generated based on the set of structured data and the set of unstructured data; in response to the ML predictive model generating the plurality of tasks, determine a sequential ordering for the plurality of tasks; display the plurality of tasks in a user interface in accordance with the sequential ordering; modify, based on a monitored set of one or more conditions, the sequential ordering of the plurality of tasks in the user interface by modifying a position of a first task included in the user interface, wherein the modified position of the first task in the user interface is a higher position located proximate to or at a topmost task position within the user interface; and trigger a notification informing a user associated with the first task of the modified position of the first task.

In some aspects, the techniques described herein relate to a computer system including: a processor system; and a storage system that stores instructions that are executable by the processor system to cause the computer system to: access a first source associated with a first domain, wherein the first source includes a set of structured data; access a second source associated with a second domain, wherein the second source includes a set of unstructured data; access a set of task structuring rules that govern how one or more tasks are to be formatted; generate a prompt for a machine learning (ML) predictive model, the prompt including the set of structured data, the set of unstructured data, and the set of task structuring rules, wherein the prompt further includes a directive to generate a plurality of tasks worded in accordance with the set of task structuring rules, where the plurality of tasks is generated based on the set of structured data and the set of unstructured data; in response to the ML predictive model generating the plurality of tasks, determine a sequential ordering for the plurality of tasks; display the plurality of tasks in a user interface in accordance with the sequential ordering, wherein a first task included in the plurality of tasks is located proximate to or at a topmost task position within the user interface, wherein the first task is associated with a target destination; monitor global positioning system (GPS) data of a user associated with the first task; determine that a trend of the GPS data indicates that the user is traveling away from the target destination; and modify the sequential ordering of the plurality of tasks in the user interface by modifying a position of the first task included in the user interface, wherein the modified position of the first task in the user interface is a lower position that is not located proximate to or at the topmost task position within the user interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIGS. 1A and 1B illustrate an example computing architecture and application programming interfaces (APIs) for dynamically generating a task list based on information obtained from multiple different sources/domains.

FIG. 2 illustrates various examples of different domains.

FIG. 3 illustrates an example user interface displaying a dynamically generated task list.

FIG. 4 illustrates another example user interface illustrating how assignments can be made.

FIG. 5 illustrates another example user interface illustrating different metadata that can be attributed to a task.

FIG. 6 illustrates how a source can be referenced and how tasks can be generated based on that source.

FIG. 7 illustrates information that may be included in a source.

FIG. 8 illustrates a populated task list.

FIG. 9 illustrates an alternative view of a task list.

FIG. 10 illustrates how external factors can result in the dynamic modification of a task list.

FIGS. 11A and 11B illustrate flowcharts of an example method for dynamically generating a task list.

FIG. 12 illustrates an example task list within which a user can trigger the purchase of an identified item that may be listed in a third-party platform, such as an online shopping platform.

FIG. 13 illustrates an example billing activities user interface (UI).

FIG. 14 illustrates an example computer system that can be configured to perform any of the disclosed operations.

### DETAILED DESCRIPTION

Many existing systems for managing communications operate in a manner similar to a single threaded system. For instance, when a communication is received, those systems myopically focus on that single communication or, in some cases, end up ignoring the communication for a prolonged period of time. The use of those traditional systems results in significant waste in computing and personnel resource as well as time management.

Stated differently, it is often the case that multiple different actors are tasked with working with one another. Often, certain events (e.g., perhaps software version updates or other disruptive events) are to transpire. But, due to failures in the communication vectors and due to deficiencies in those communication techniques, these events are not properly handled or are not routed to those individuals who have the capability to properly address those events, resulting in those events transitioning from potentially being relatively minor to potentially being highly disruptive or even breaking.

The disclosed embodiments bring about numerous advantages, benefits, improvements, and practical applications to the general field of communication management. Whereas traditional techniques generally operated in a single threaded manner, the disclosed embodiments are able to beneficially operate in a multi-threaded manner to achieve significant improvements in resource management and utilization.

Additionally, the disclosed embodiments are able to access data distributed across multiple different sources and domains, including third-party domains. The embodiments can then aggregate this data in an intelligent manner, such as via the use of machine learning, to generate a structured task list that is designed to assist users in accomplishing multiple different action items. As external data is obtained, this task list can be dynamically modified to account for newly obtained data, thereby enabling further efficiency improvements. The generation of this dynamic task list helps avoid scenarios in which action items are missed or ignored.

The disclosed embodiments are beneficially structured to learn an organization's strengths and to dynamically assign tasks to the right people at the right time, thereby ensuring optimal outcomes. The embodiments are able to intelligently coordinate workflows and deadlines with intelligent task management. The embodiments can analyze performance trends to continually refine task allocation and to boost efficiency. In some implementations, these benefits can be achieved through a machine learning system in which participants are asked operational, financial, human resource, production, and executive questions over time, in conjunction with actual data monitoring of those areas.

In this sense, the embodiments are advantageously directed to continuous adaptation techniques in which a system can receive input from multiple sources, both human and machine. The system can continually or periodically monitor external systems and domains for events via instrumentation. In some cases, events or event data is gathered from the monitoring and instrumentation processes, and this data can be registered, logged, mapped, and then translated to a list of procedures or lists. Lists (aka “task lists,” “containing tasks,” or simply “tasks”) can be allocated or assigned utilizing a linear task allocation model. Lists, and the tasks they contain, can be matched to organizational goals and objectives. Goal attainment can be tied to organizational performance trends. The system can be further tuned or optimized using machine learning, specifically reinforcement learning. One beneficial feature of the system relates to matching users with the ordered tasks they need to complete in sequence to achieve their goals and objectives. Further, an objective of the system is to take into account new information and events as a primary factor of adaptation.

In this regard, the disclosed embodiments relate to a comprehensive, integrated system designed to dynamically allocate tasks within an organization to improve efficiency and to achieve strategic objectives. Accordingly, these and numerous other benefits will now be described in more detail throughout the remaining portions of this disclosure.

### Example Computing Architectures

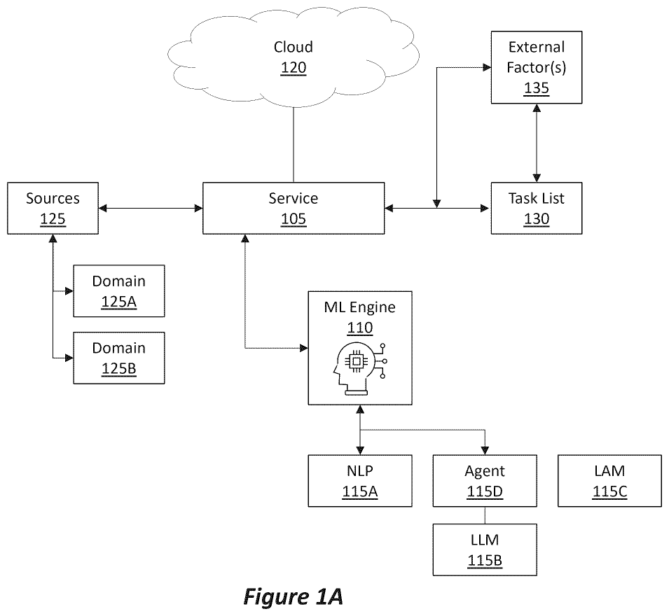

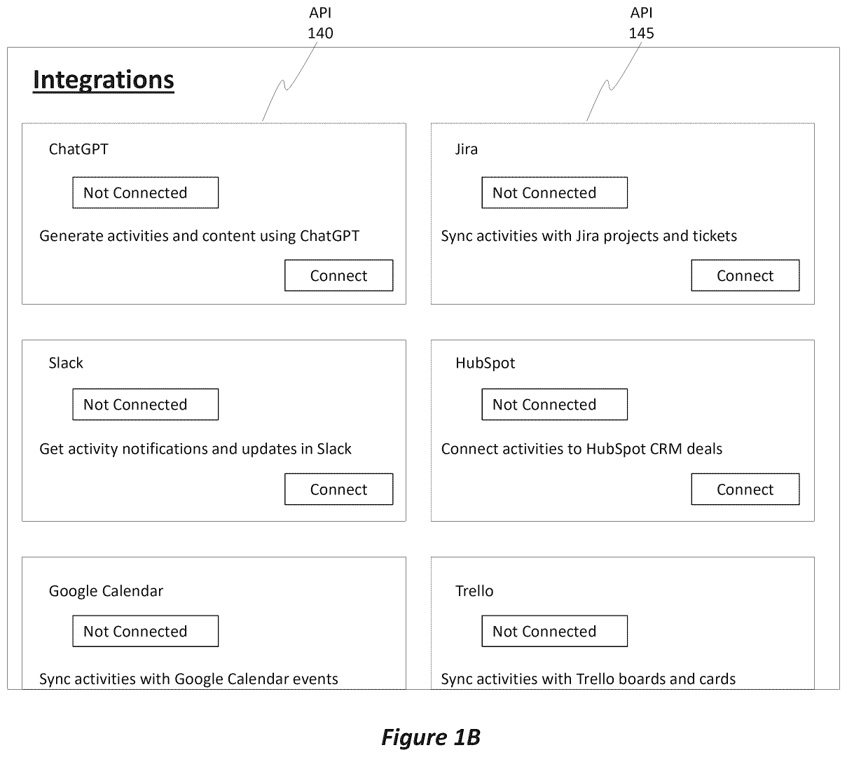

Having just described some of the high level benefits, advantages, and practical applications achieved by the disclosed embodiments, attention will now be directed to FIG. 1A, which illustrates an example computing architecture 100 that can be used to achieve those benefits.

Architecture 100 includes a service 105. As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 110. The ML engine 110 enables the service to operate even when faced with a randomization factor. Optionally, as will be discussed in more detail later, the ML engine 110 may include a natural language processing (NLP) 115A engine, which may involve the use of a large language model (LLM) (e.g., a type of machine learning predictive model) such as LLM 115B or, in some implementations, a small language model (SLM).

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees), linear regression model(s), logistic regression model(s), support vector machine(s) (“SVM”), artificial intelligence device(s), large language model, or any other type of intelligent computing system. Any amount of training data may be used (and perhaps later refined) to train the machine learning algorithm to dynamically perform the disclosed operations.

As mentioned above, service 105 may also include or implement the use of a large language model (LLM) 115B. An LLM (e.g., LLM 115B) is a type of machine learning predictive model. As such, any reference to an LLM should be viewed expansively as an artificial intelligence (AI) ML model capable of predicting and generating output. The disclosed embodiments can incorporate the use of any type of re-entrant artificial neural network that is trained on a dataset (with an LLM being one example of a re-entrant artificial neural network). This training enables the model to predict an optimal task from a prompt or from a corpus of data. The disclosed embodiments are beneficially designed to train a task-based system to optimize input data in a manner that often involves various different features and that often follows a structured process using those features.

The input to the re-entrant neural network can have various characteristics or features. For instance, the measurable properties or characteristics of the input data may of be any type, such as, but not limited to, numerical values, categorical values, alphanumerical values, text, images, video, audio, and so on. In some scenarios, the input can be associated with labels, such as for supervised learning implementations. These labels can help guide the model during its training or prediction phase.

The model architecture generally relies on various trained algorithms. These algorithms are the computational methods used to train the model. Common algorithms include linear regression, decision trees, and neural networks. These algorithms rely on parameters, which can include internal variables that are adjusted during training to optimize the model's performance.

During the training process, the model is presented with any number of different training sets. A training set can be viewed as a subset of data that is used to train the model. It may include both features and label information. In some scenarios, the training may rely on a validation set, which is a separate subset used to tune hyperparameters and to prevent overfitting by validating the model's performance. The test set is the final subset used to assess the model's performance on unseen data.

Desirably, the model is optimized, and this optimization can be determined using a loss function. A loss function is a metric used to evaluate how well the model's predictions match the actual labels. Generally, the goal is to minimize this function. The optimization algorithm relies on various techniques, such as a gradient descent that is used to minimize the loss function by adjusting the model's parameters.

The model can also be evaluated using any number or type of evaluation metrics. These metrics can be used to evaluate the following: accuracy, precision, recall, F1 score, and mean squared error (MSE) to measure the model's performance.

The model's hyperparameters refer to settings that govern the training process. These settings include, but are not limited to, the learning rate, batch size, and number of epochs for the model. These hyperparameters are not learned from the data but rather are set before training.

The typical structure or procedure for implementing a re-entrant artificial neural network is as follows. A data collection and preprocessing step is performed in which raw data relevant to the task is gathered. Optionally, this data is cleaned or sanitized to handle missing values, outliers, and noise. Optionally, the data can be anonymized to remove personally identifiable information. The process then includes transforming and normalizing the data to standardize the input features.

The features can then be modified or further engineered. For instance, the engineering process can involve selecting relevant features that have predictive power and creating new features through domain knowledge or data transformations.

The model is selected. The selection process involves choosing an appropriate machine learning algorithm based on the problem type (e.g., classification, regression, clustering, etc.). If the model requires training or additional tuning, then that can also occur. The training can include splitting the data into training, validation, and test sets and then training or further tuning the model on the training set as well as potentially adjusting parameters to minimize the loss function.

Often, the model is then validated. This validation involves evaluating the model on the validation set to tune hyperparameters and to avoid overfitting. The process can also include using techniques, such as cross-validation, to ensure robust model performance. After validation, the model can be tested. The testing process may include assessing the model's final performance using the test set and potentially reporting evaluation metrics to quantify the model's accuracy and reliability. After the testing, the model is deployed. Deployment includes integrating the trained model into a production environment so the model can make predictions on new, unseen data. The deployment can also include monitoring the model's performance over time. This monitoring may include periodically triggering one or more retraining events so the model can be further tuned using new data so as to maintain the model's accuracy.

In some scenarios, the model may be further optimized. This optimization can include continuously monitoring and improving the model by iterating through the training process with new data and improved techniques. In this manner, a re-entrant artificial neural network can effectively optimize input data for specific tasks, ensuring robust performance and adaptability in real-world applications. Accordingly, in some implementations, a re-entrant artificial neural network, an LLM, or any type of artificial intelligence (AI) ML model can be used herein.

In addition or as an alternative to the NLP 115A and the LLM 115B, service 105 can also include or implement the use of a large (or small) action model (LAM), as shown by LAM 115C. The LAM 115C is another example of an artificial intelligence engine. The LAM 115C is trained to understand human intentions, tasks, goals, or actions and then translate that understanding into a workable action item (e.g., perhaps by generating a task list). In this sense, the LAM 115C can take additional steps beyond those of the LLM 115B because the LAM 115C can not only understand and interpret tasks but can also facilitate in the performance of those tasks. The LAM 115C can recognize a high level objective and can distill that high level objective into a number of discrete, smaller sized action items, the combination of which, when achieved, results in the achievement of the high level objective. Thus, the LAM 115C is specially trained to break a complex action into any number of smaller actions and then attend to, or assist in, the performance of those action items.

The LAM 115C can also be trained to handle different scenarios. For instance, the LAM 115C can be trained to handle queries, scheduling task items, or any other action items. The LAM 115C can receive and analyze any type of input, including client data. Thus, the LAM 115C can be trained to understand details and complex natural human language and goals and break that detailed language into a number of actionable tasks that can be performed. The collective performance of these smaller tasks will result in the completion of the overall goal that was described by the client. As used herein, any reference to the ML engine 110, the NLP 115A, the LLM 115B, or the LAM 115C can be interchanged with any of these other references. For instance, any reference to the ML engine 110 can be interchanged with any one or more of the NLP 115A, the LLM 115B, and/or the LAM 115C. Similarly, any reference to the NLP 115A can be interchanged with any one or more of the ML engine 110, the LLM 115B, and/or the LAM 115C. Any reference to the LLM 115B can be interchanged with any one or more of the ML engine 110, the NLP 115A, and/or the LAM 115C. To complete the example, any reference to the LAM 115C can be interchanged with any one or more of the ML engine 110, the NLP 115A, and/or the LLM 115B.

Accordingly, a “large language model” (LLM) is a specialized type of machine learning (ML) or artificial intelligence (AI) model that has been trained on a large set of data. The data can be of any type, though it is often text-based data. Image data, video data, and other data types can also be used. With its training, the LLM is able to understand and produce output that resembles human-generated output. As various examples, an LLM can be tasked with translating input from one language (e.g., perhaps English) to another language (e.g., perhaps Spanish). LLMs can be tasked with answering questions, writing code, analyzing language patterns, and writing creative content. LLMs can be involved with an “agent.”

An “agent” (e.g., agent 115D) is a type of system or service that leverages one or more LLMs to perform a task, which refers to a unit of work that needs to be performed. Notably, an agent is a type of autonomous system that can “think” and act on its own; meaning, it can operate without specific instructions from a user. In some scenarios, an agent has a defined goal (either set by a user or a developer), and the agent can select an appropriate strategy to accomplish a given task using available tools.

An LLM will respond to a question if asked. For instance, if an LLM is asked: “What is the price of a plane ticket to Machu Pichu?” the LLM can generate a response. An agent, on the other hand, can not only provide a response, but it can also go about scheduling and paying for the flight. The agent can also book a hotel and vehicular travel arrangements.

The LLM agent 115D can operate on top of the LLM 115B and can be included as a part of the ML engine 110. Thus, in some implementations, service 105 is implemented as or at least includes the LLM agent 115D. As used herein, the phrases “service” and “LLM agent” (or simply “agent”) can be used interchangeably. It should be noted how the service/agent are able to use various application programming interfaces (APIs) as well as data made available to it to perform various actions. The APIs typically are not structured to perform specific actions; rather, the APIs provide the service/agent the interface for communicating with data models and other data to achieve a specific desired outcome. The combination of the agent 115D and the LLM 115B can be used to implement the LAM 115C. Thus, in some embodiments, the LAM 115C is the same or substantially the same as the agent 115D, when coupled with the LLM 115B. As will be discussed in more detail later, the agent 115D (or rather, the LAM 115C) is tasked with generating a list of action items. The agent 115D is able to use AI to analyze an incoming set of data (e.g., perhaps a message, such as an email) and automatically generate an action item corresponding to that data. Additionally, it may be the case that the data is structured in accordance with a first format or, alternatively, the data may not have a structured format (e.g., consider a free-flow text message). Regardless of whether a format is or is not detected for the data, agent 115D is able to generate a new task list action item that is structured in accordance with a predefined or standardized format. Thus, in accordance with the disclosed principles, the embodiments are able to transform data structures or data from one format into a new data structure having a standardized format.

LLM agent 115D can include or be associated with memory and any number of different tool(s) or APIs, which refer to specialized utility, tooling, or functionality defined for the agent 115D to use. Examples of APIs will be provided later with reference to FIG. 1B.

In some implementations, service 105 is a cloud service operating in a cloud 120 environment. In some implementations, service 105 is a local service operating on a local device. In some implementations, service 105 is a hybrid service that includes a cloud component operating in the cloud 120 and a local component operating on a local device. These two components can communicate with one another.

Service 105 is generally tasked with accessing one or more sources 125. Sources 125 may be associated with any number of different domains, such as domain 125A and domain 125B. As a quick example, domain 125A may be an email domain, and domain 125B may be a text message domain. Of course, other domains can be used. Examples of other domains include, but certainly are not limited to, a website domain, any type of application domain, and so on, without limit. Service 105 analyzes the content in those sources 125 and generates a task list 130 based on the content. In one example, service 105 uses AI or the agent 115D to recognize tasks within the content. This task list represents a listing of action items that are structured in a specific manner, potentially so as to achieve a defined objective, which the service 105 is able to generate. Optionally, the action items in the task list 130 may be modified or at least rearranged based on the detection of various external factor(s) 135, which may be detected by the service 105.

Generally, service 105 is able to receive input from multiple sources, both human and machine. Service 105 can also monitor external systems and domains for events via instrumentation or any type of monitoring. Service 105 can register and log events detected through the monitoring process. Service 105 can map and translate registered events into a list of procedures or lists of tasks, which are organized in accordance with at least one format standard. Service 105 can also allocate tasks within the lists based on a linear task allocation model designed to balance workloads across different business areas while optimizing overall efficiency. Optionally, service 105 can match tasks and the lists containing them to organizational goals and objectives. Task allocations can be adjusted based on organizational performance trends detected through continuous monitoring. Service 105 can also be optimized using machine learning, specifically reinforcement learning, to continuously improve task allocation and organizational performance. Optionally, the task allocation can also be adapted in response to new information and events to enhance the achievement of organizational goals and objectives.

Optionally, service 105 can include a logging module for registering and storing events detected by an event monitoring module. Service 105 may also include a mapping module configured to translate the registered events into lists of procedures or tasks. A task allocation module can utilize a linear equation-based model to allocate tasks across various business areas based on predefined efficiency metrics. A goal matching module can align the allocated tasks with the organizational goals and objectives. A performance trend analysis module can modify task allocations based on the detected performance trends. A machine learning module can employ reinforcement learning to continuously optimize the overall system efficiency and task allocation. An adaptation module can update task allocations and system operations in response to new incoming information and events, thereby ensuring continuous alignment with organizational goals. The above “modules” and engines can all be included as a part of service 105.

Service 105 can implement an automated monitoring system to detect events across multiple external domains. Service 105 can utilize a centralized logging system to ensure all relevant events are captured and recorded. The mapping system can convert events into actionable tasks organized into lists. These tasks can be dynamically allocated using a mathematical model that ensures optimal balance and efficiency. Task allocations and overall system operations can be dynamically adapted in response to evolving external conditions and internal performance feedback.

As will be described shortly, service 105 can also provide one or more user interfaces (UIs) configured to facilitate interaction with the service 105. Through these UIs, service 105 can receive input from multiple sources, both human and machine. The UIs can display the lists of procedures or lists of tasks in an interactable manner.

Service 105 can also include a price and time optimization model that estimates the cost and duration of tasks based on historical data, current market conditions, and resource availability. The models can minimize a particular factor (e.g., perhaps price or time) and/or can maximize a particular factor (e.g., priority). Matching tasks, along with their estimated costs and durations, to organizational goals and objectives, ensures financial and temporal feasibility.

Service 105 can prompt users of the system (e.g., perhaps via UI prompts) to regularly and asynchronously contribute. For example, users may be asked questions, such as which tasks are useful, which delegates are performing well, and which goals drive the most impact.

For example, a system user might be asked “Do you still prefer sending website related tasks to John?” A “Yes” answer would reinforce John's position as a primary delegate. The system might ask for permission as well, such as “Would you like to delegate this task to John?” Additionally, service 105 might ask questions about priorities to multiple members of an organization to drive consensus.

For example, service 105 can ask three members of an organization, “Is the annual report still a top priority?” If the answer is unanimous, the tasks, lists, and goals will stay the same. If there is a differing opinion of priority, service 105 can recommend an escalation to another action, such as a meeting, a communication, or an override. Further details on these aspects will now be provided in the remaining figures.

FIG. 1B shows various APIs (e.g., API 140 and API 145, among others) that the agent 115D and/or the service 105 can connect with. By connecting across domains via the different APIs, the service 105 can implement tools and data from third-party sources to perform at least some of the disclosed operations.

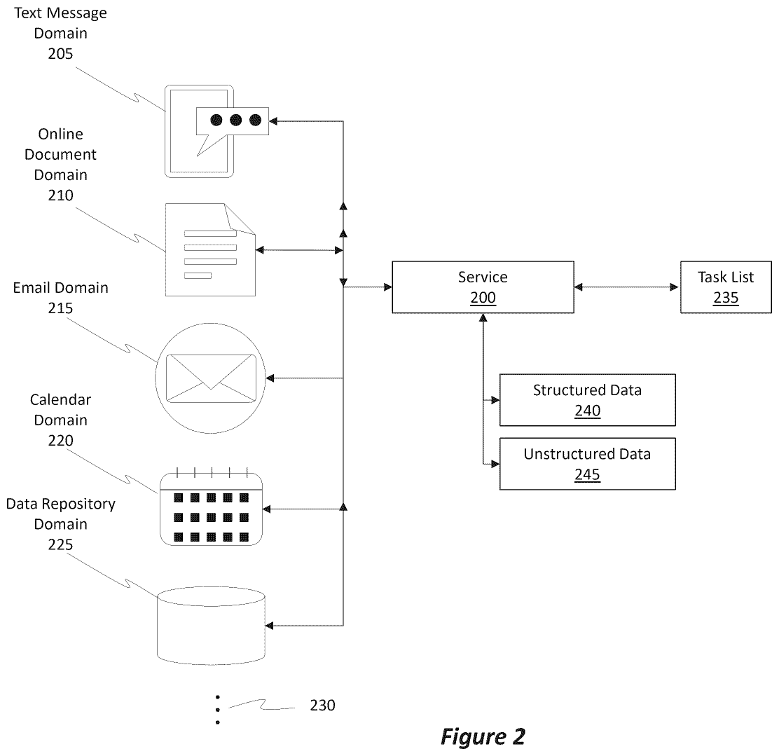

FIG. 2 shows a service 200, which is representative of service 105 from FIG. 1A. FIG. 2 also shows a number of different sources having different domains. These sources correspond to the sources 125 of FIG. 1A.

To illustrate, service 200 is able to access a first source having the form of a text message domain 205. This text message domain 205 may operate or be hosted on a smart phone or some other type of smart device.

Service 200 is able to access a second source having the form of an online document domain 210, such as perhaps a Google Document. This online document domain 210 can be structured to enable collaborative editing by any number of users who have access to the document. The document may be in the form of a word editing document, a spreadsheet, a notepad, a database, or any other type of editable platform.

Service 200 is also able to access an email domain 215. This email domain 215 can be any type of email, without limit. Service 200 is also able to access a calendar domain 220 for a user. Service 200 can also access any type of data repository domain 225, such as a Data Lake, a cloud storage repository, or any type of data storage platform. The ellipsis 230 shows how service 200 can access any other domain, without limit (e.g., any type of website, folder data structure, transcripts, repositories, etc.).

These various different domains will store information that can be analyzed, parsed, embedded, and/or vectorized by the service 200 to generate a task list 235, which is representative of the task list 130 from FIG. 1A. In some cases, the different domains include structured data 240 while in other cases the different domains include unstructured data 245. As an example, consider a database domain. This database stores data in a specific configuration defined by the parameter fields of the database. Thus, the data stored in a database can be viewed as being structured data 240. Similarly, it is typically the case that data stored in a spreadsheet is organized in a specific manner. Thus, spreadsheet data can also be considered as being structured data.

In contrast, consider the data sent in a text message. Often, text messages include various different sentences or sentence fragments that are often not organized into a list format or other structured format. If the text message is organized into a list format, then the text can potentially be considered as structured. Regardless, when the text is not in a structured format, service 200 can employ its machine learning algorithm, such as perhaps its NLP engine or the LLM 115B to provide a semantic understanding of the text so as to provide structure to the text. Examples of such actions will be provided later.

Service 200 can analyze the data distributed across these various domains to generate the task list 235. In some cases, the task list 235 is organized in a manner so as to achieve a determined sequential ordering for the tasks. For instance it might be the case that service 200 identifies five total tasks, numbered 1 through 5. It might be the case that task 3 is dependent on task 2, and task 5 is dependent on task 4. In such a scenario, service 200 is able to recognize these dependencies and organize the task list to reflect a sequential ordering of tasks, such as by ordering the tasks according to their identified dependencies. Deadlines can also be used to order the tasks.

Another example will be helpful. Suppose a first person sends a second person a text message saying: “please pick up some ice cream on your way home.” The first person also sends the second person an email message saying: “please print this form off so we can file it with the school.” Service 200 is able to analyze the data obtained from these various different sources and compile the data in a structured format so as to generate the task list 235. The task list 235, as will be described in more detail later, has a structured data format that is designed to facilitate the achievement of an overall goal or objective or to satisfy a number of sub-goals or achievements. For instance, the task list 235 may be labeled as “Action Items For Today,” and the list may include the various different tasks that the second person is to achieve, including purchasing the ice cream and printing off the form. In the above example, the task corresponding to the email message will be prioritized over the task in the text message due to a timing priority. Notice, the email message is requesting that something be printed prior to the person leaving work, whereas the text message is requesting that something be purchased while that person is traveling from work to home. Service 200 is able to identify the timing differences between these two tasks and ensure that the email task is prioritized over the text task because the email task needs to be accomplished while the person is still at work whereas the text task needs to be accomplished after the person has left work.

As yet another example, consider a scenario involving an update to a software application. The rollout of this update may involve 10 different tasks being completed by 3 different individuals. Service 200 is able to generate these different tasks and populate a task list. Service 200 can also facilitate the assignment of those tasks to the responsible developers.

In some implementations, the title for the task list can be intelligently created by the service 200 based on the type of tasks that are identified. For instance, the above set of tasks for the second person relate to household duties. It might be the case that service 200 analyzes these activities and generates the following title for this set of tasks: “Household Tasks For Today.” This title is based on a determined subject matter of the identified tasks. Groups of tasks can be organized based on common characteristics, and a group name can be assigned to that group.

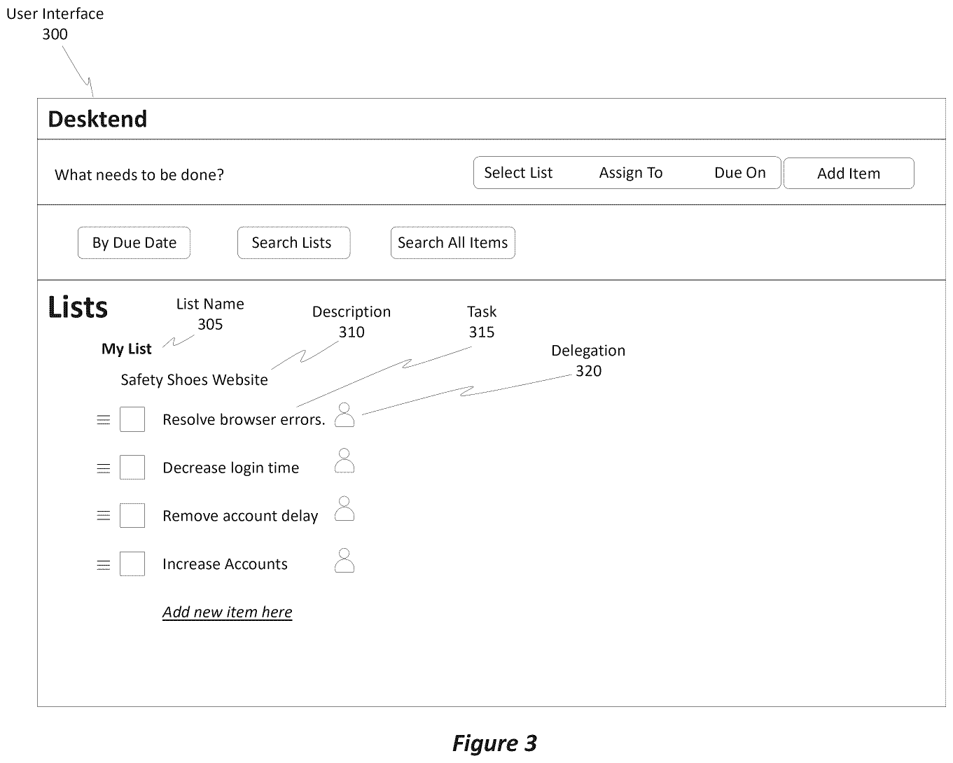

Having just described some of the disclosed principles at a high level, attention will now be directed to FIGS. 3 through 10, which illustrate various different user interfaces and supporting illustrations to demonstrate how these principles can be employed. It should be noted that these user interfaces are provided for example purposes only, and they should not be viewed as being limiting with respect to the disclosed concepts.

### Example User Interfaces

FIG. 3 shows an example user interface 300 for displaying a task list, such as the task list 235 of FIG. 2. Prior to the display of user interface 300, service 105 of FIG. 1A accessed any number of different sources and parsed out actionable task items from those sources. Service 105 may also have generated or modified text to reflect the actionable task items. That is, in some scenarios, service 105 generated a new body of text based on the source text, where this new body of text is organized in accordance with a predefined structure or format. Service 105 then populated the user interface 300 using these various different tasks. Additionally, or alternatively, a user can manually enter tasks into the task list.

User interface 300 shows a list name 305 which is a generalized name that provides an umbrella description for the set of tasks. In this case, the list name 305 is simply “My List.”

User interface 300 also includes a description 310 for the task list. In this scenario, the description 310 includes the following text: “Safety Shoes Website.” This list includes a set of action items that generally pertain to a website about safety shoes.

The task list is shown as including four different tasks, one of which is labeled as task 315. Task 315 includes the following action item: “Resolve browser errors.” This action item is one a developer may take to fix or resolve certain errors that a user's browser is having with regard to the website. In this example scenario, a specific grammatical format is being used for each task item. Here, the grammatical format involves the use of a verb followed by an object. Of course, other formats can be used as well.

It should be noted how the list name 305, description 310, and the task 315 can also be generated automatically by the service 105. Customized text can be crafted by the service 105 to reflect the task list, the description, and the various tasks.

Modifications to the ordering of the list can also be made. For instance, the three lines to the left of each action item is a user interface element that allows the user to customize the ordering of the action items by moving them up or down in the listing. A higher position in the task list often reflects a higher priority for that task. Automatic modifications can be performed as well. As one example, suppose a task item is associated with a specific location, such as a store. Service 105 can access global positioning system (GPS) data for the user. If the user nears the store, service 105 can automatically rearrange the task items to prioritize the item involving the store because of the user's proximity to the store. Thus, in some implementations, the embodiments can receive an indication that the tasks in the task list are to be organized based on a specific criteria, such as perhaps GPS data. The embodiments can continuously and/or periodically update the GPS data over a predetermined period of time to track whether the task can be completed based on the GPS data. The embodiments can automatically move the UI element corresponding to the task in the task list to a top-most position or some other predetermined position in the UI based on the monitored GPS data.

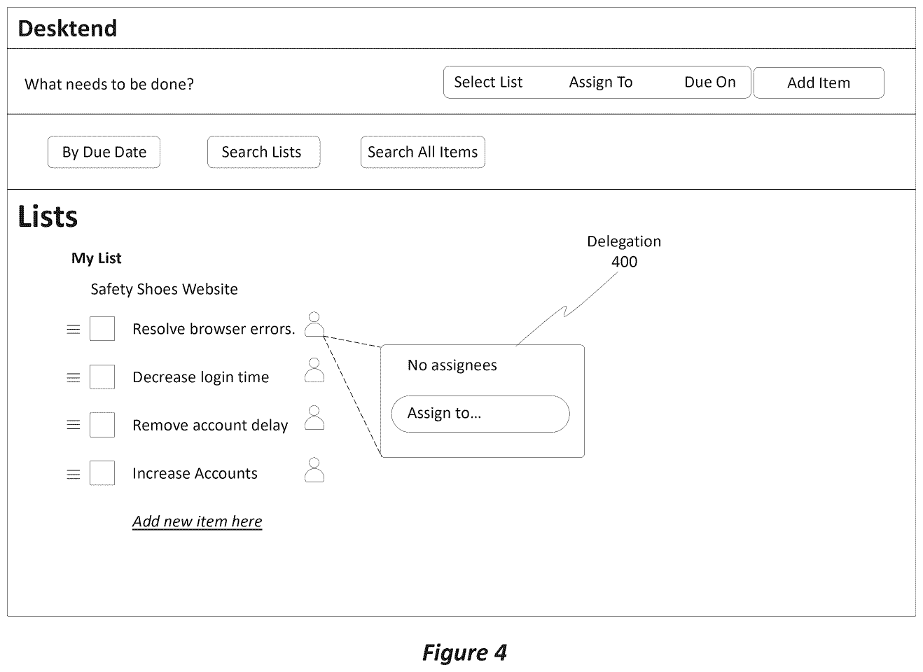

User interface 300 also shows an option to delegate or assign a specific task to a specific user, as shown by delegation 320. The result of assigning the task to a specific user is that the user is now responsible for managing and completing this task. FIG. 4 provides some additional details.

FIG. 4 shows how, by selecting the avatar icon next to the task item, a new delegation 400 window will be displayed. A user can use this window to assign the task item to a specific user by entering the designated user's information (e.g., name, email alias, etc.) into the window. Entering this information can optionally trigger an alert or notification to be sent to the specific user. This alert can be transmitted using any type of communication protocol, such as a text message, an email, a chat message, and so on. The alert will inform the user that the user has been assigned or delegated to managing this specific task.

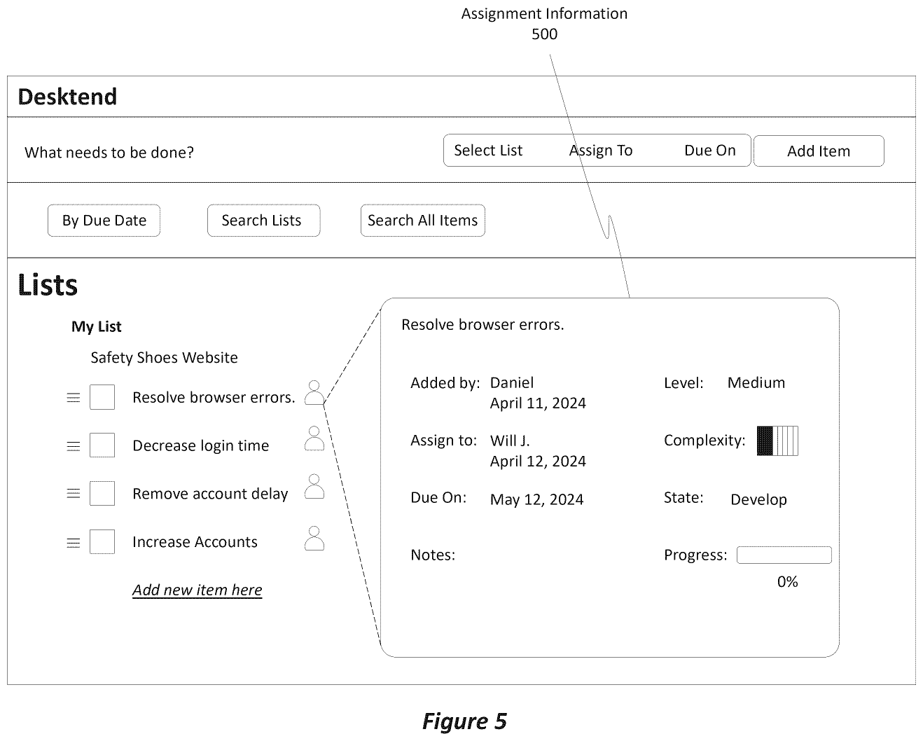

FIG. 5 shows another scenario involving the display of assignment information 500, or metadata associated with a given task. Notice, the first task in the list was assigned (e.g., based on the information included in the assignment information 500 window) to “Will J.” The window details the timestamp as to when this assignment occurred and who facilitated or initiated the assignment (e.g., “Daniel” assigned the task to “Will J.”). The window further specifies a due date for the task, a level of involvement that will likely be required (e.g., in this case the involvement level is “medium”), a complexity level, a current state or status of the task, and a completion progress indicator for the task. The window further includes an option to enter additional notes or comments about the task.

Each task in the task list can include similar information corresponding to that specific task. For instance, a first task might be assigned to a first user while a second task might be assigned to a second user. In some cases, all of the tasks might be assigned to the same user. In other cases, all of the tasks might be assigned to different users. In yet other cases, multiple tasks may be assigned to a first user and multiple other tasks may be assigned to a different user. When a task is assigned to a user, that user's client instance of the task list can be updated to reflect the assignment. Similarly, the person who made the assignment can have that person's own client instance be updated to reflect the assignment.

Optionally, the assignor of a task may also be notified when a task is updated or completed. In some cases, the service may continuously or periodically monitor the source of the task and alert the assignor or any other optional entity when a task is either completed, modified, updated, added to a list, or undergoes a position change in the list indicating changing priority.

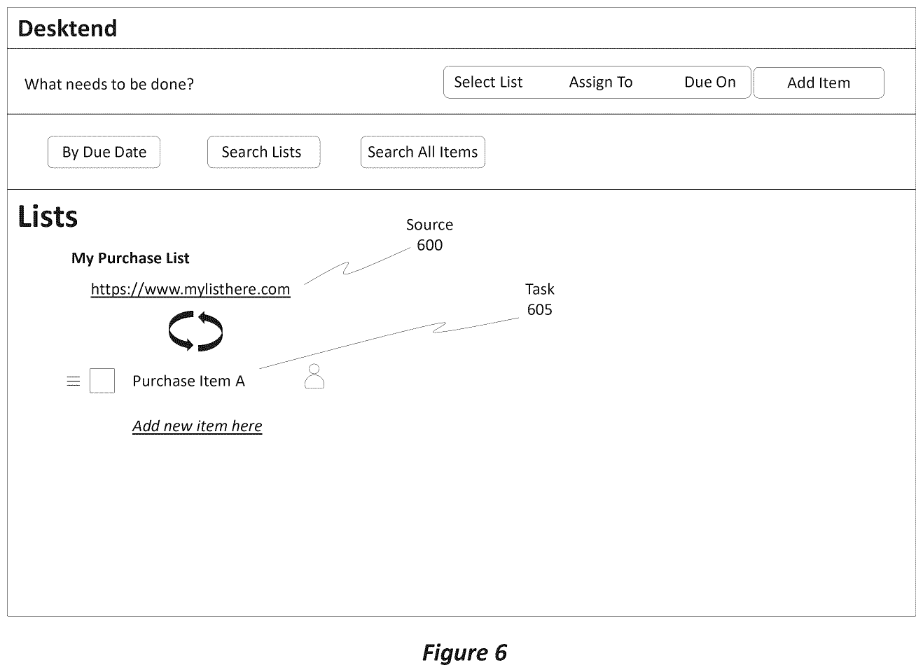

FIG. 6 illustrates a scenario where a source 600 is entered as input to the task list. When a source 600 is entered as input, service 105 of FIG. 1A can be triggered to access that source 600 (e.g., by navigating to the source 600) and extracting action items from that source. Service 105 may then populate the task list using the identified items. In this example scenario, service 105 is currently populating the task list. So far, only a single action item/task 605 has been generated and populated.

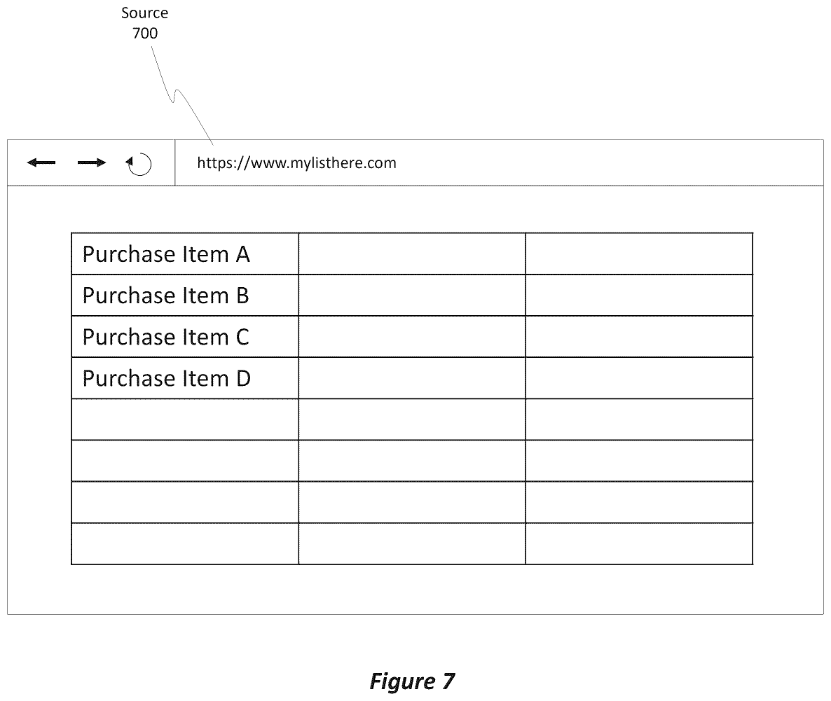

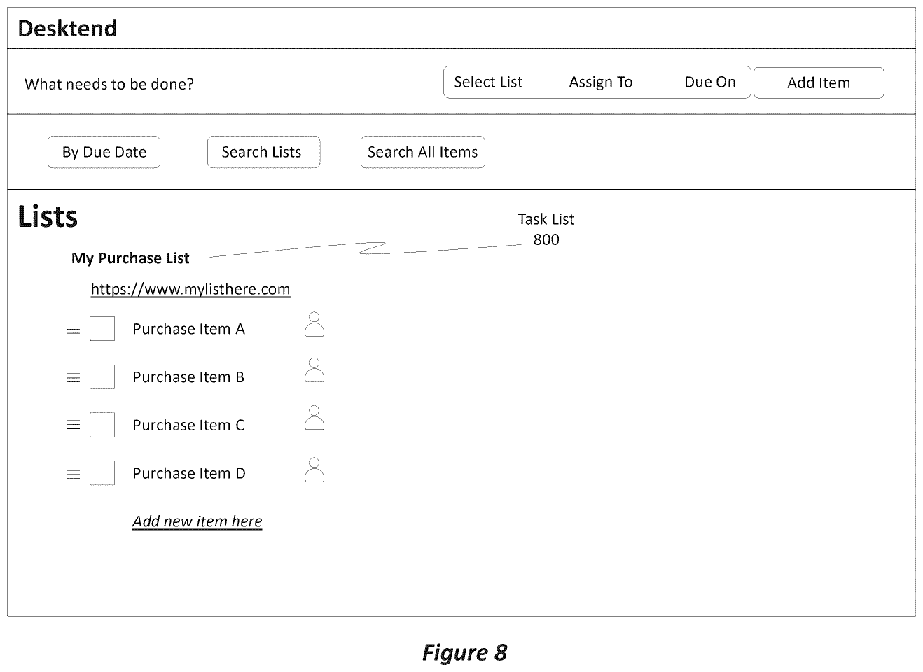

FIG. 7 shows an example source 700 that is representative of the source 600 from FIG. 6. In this scenario, source 700 is a website that lists various items, as shown by “Purchase Item A,” “Purchase Item B,” “Purchase Item C,” and “Purchase Item D.” In this scenario, source 700 can be considered as a collaborative online editing spreadsheet. Of course, these action items are simply provided for example purposes and should not be viewed as being limiting. Service 105 is able to analyze the source 700 to detect and/or generate the various different action items that may be embedded in the source 700. Service 105 can then generate the task list. FIG. 8 is illustrative. FIG. 8 shows a resulting task list 800 identifying the various different tasks that have been generated based on the information included in the source 700 of FIG. 7. Notice, the various different purchase activities are currently shown in the task list 800.

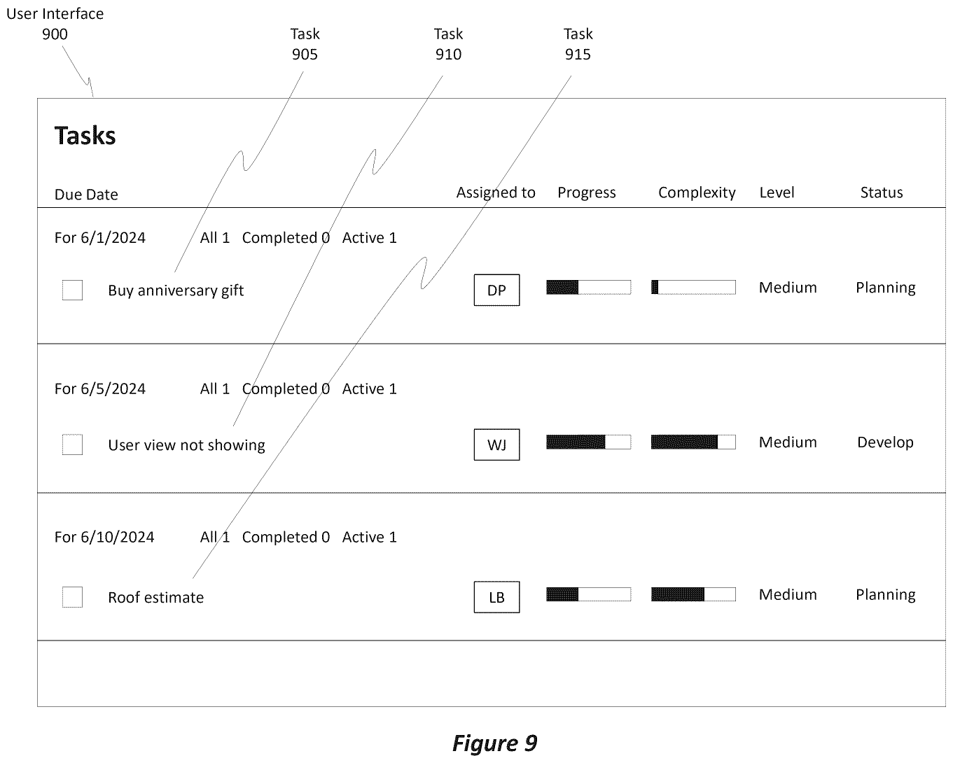

FIG. 9 shows an alternative user interface 900 that lists activities or tasks based on the various due dates as opposed to being included within a common or single task list. That is, whereas the previous task lists displayed tasks that were included in the same list, FIG. 9 shows tasks that are distributed among multiple different task lists and that are now arranged based on due dates. To illustrate, task 905 originates from a first task list that may have any number of action items. Task 910 originates from a second task list that may have a different number of action items as compared to the first task list. To complete the example, task 915 originates from a third task list. Despite tasks 905, 910, and 915 being from different lists, these tasks are displayed in the user interface 900 in a manner that reflects their upcoming due dates.

As mentioned previously, service 105 can dynamically modify the task list based on any number of detected external factor(s) 135. These external factors can include, but certainly are not limited to, any type of position data (e.g., GPS data), sensor data (e.g., an Internet of Things IoT sensor device), wearable device data (e.g., a wearable sensor, such as a heart monitor), and so on without limit.

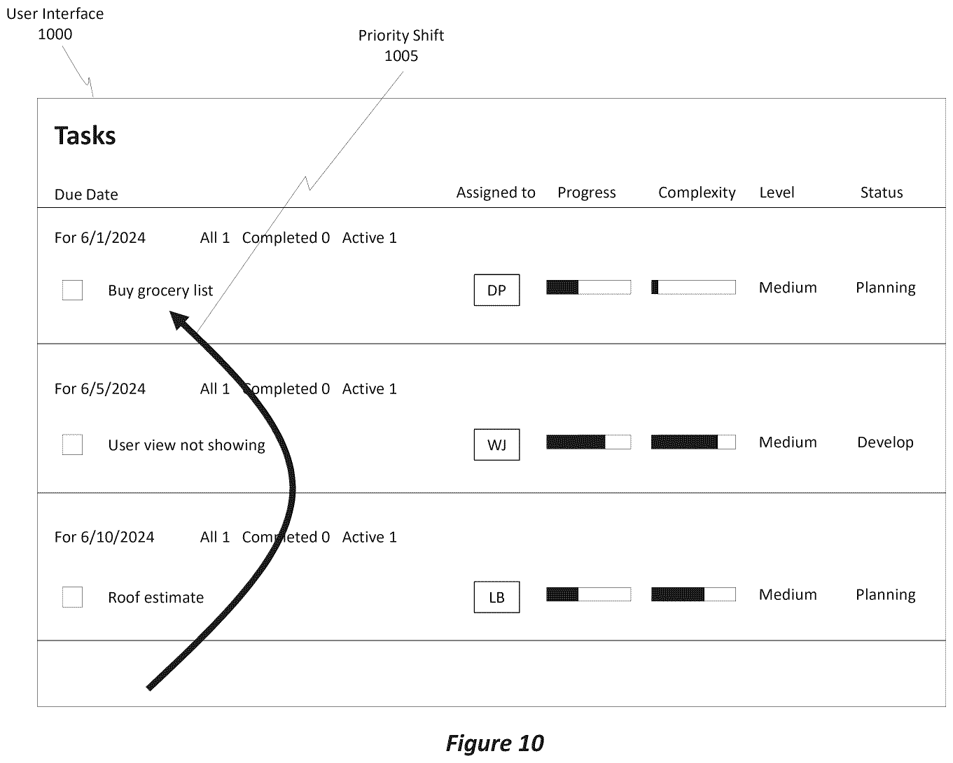

FIG. 10 illustrates an example where service 105 is monitoring the geographic location of a user using GPS data. In this example scenario, service 105 has determined that the user is physically proximate to a grocery store or perhaps is within a threshold distance of the store or perhaps is on a trajectory that will take the user within a threshold distance of the store. Because of this proximity, service 105 dynamically modifies the task list by bringing a previously un-displayed task item to the forefront, or rather, to the top of the list. For instance, in FIG. 10, user interface 1000 now shows how the “Buy grocery list” is elevated to the top of the task list because of the user's proximity to a grocery store, as determined by the user's geographic location, which may be determined by accessing the user's smartphone to determine location. Thus, FIG. 10 shows an example scenario of a priority shift 1005 in which service 105 dynamically modified the task list based on one or more external factors. Optionally, service 105 can trigger a reroute of the user's travels to add a new destination (e.g., the store) so that the user makes sure to complete this task. Adding the new destination can occur, in one example, via the use of Google Maps.

Returning to FIG. 1A, the ML engine 110 can initially be trained using a first set of training data. This training phase can involve teaching or training the ML engine 110 to identify actionable tasks from one or more sources. As an example, suppose a first source is a text message and includes the following language: “we need to remember to take out the garbage tonight.” This text can be fed as training data to the ML engine 110 to teach the ML engine 110 to recognize similar text as being an actionable task item. Furthermore, the ML engine 110 can be trained to generate language that describes the task and that adheres to a set of task structuring rules that govern how tasks are worded.

For instance, the task structuring rules may dictate that a task is required to be organized in the following manner: verb/action language followed by subject/object language. Using the garbage example, the task structuring rules may cause the ML engine 110 to be trained to generate the following language to represent the garbage task: “take out the garbage.” ML engine 110 can also be trained to generate metadata for each task, where the metadata can optionally include a due date (e.g., in this example, the due date is today, perhaps by 9:00 pm) as well as an initial assignment to an individual (e.g., perhaps myself). Optionally, satellite data can be obtained (e.g., perhaps from Google Earth or Google Maps) to add a location to the task. For instance, the location can be GPS coordinates as to where to place the garbage cans so they can be collected. Optionally, image data can also be provided, such as a picture of the street where the garbage cans are to be placed.

In some cases, ML engine 110 can be trained to generate a prompt to operate as input to an LLM 115B so the LLM 115B can generate the language for the task. Optionally, the task structuring rules can be included in the prompt so the LLM will structure the task language based on those rules. For instance, the prompt may include the task structuring rules, the language from the source (e.g., “we need to remember to take out the garbage tonight”), as well as a directive to generate task language that adheres to the rules. The LLM can then generate the language, and service 105 can use that language to populate the task list. Thus, service 105 can provide input to the LLM as well as instructions to the LLM. The LLM may then generate output, and service 105 can use that output to populate the task list. Accordingly, during the first training phase, ML engine 110 can be trained to perform these various actions.

The ML engine 110 may also be trained to recognize the same task was updated or completed and remove it from the task list or update the wording according to the task structuring rules. While the service 105 is continuously or periodically monitoring the source, suppose another text message is received with the wording: “I took out the garbage, but we are out of garbage bags.” The ML engine 110 can then recognize that one task was completed and remove it from the list, and additionally add a new task to the list, “buy garbage bags,” with the option to notify other users that a task was updated or added.

Subsequently, ML engine 110 can be subjected to a second training phase in which the ML engine 110 is further trained or further refined based on user feedback, based on detected user behavior with respect to the task list, or based on other identified events. For instance, service 105 can monitor how a user interacts with the task list. It might be the case that users repeatedly modify the task list in a similar manner or modify the task language in a similar manner. If that is the case, these activities can be monitored and used as additional training data to further train the ML engine 110. Thus, ML engine 110 can learn in an iterative manner and can improve and adapt over time.

With many users, very large listings of action items result in those users losing interest or ambition with respect to those action items. Service 105, with its ML engine, is able to learn the behaviors of users and determine what a maximum threshold of action items a user can tolerate. For instance, the ML engine can detect that a first user is highly proactive and engaged when her task list has 10 items or fewer. When the list exceeds 10 items, ML engine might detect a loss in productivity due to the list being overwhelming. Based on the learned behavior of this user, ML engine can dynamically throttle or limit the number of action items that are in the task lists for the first user.

A second user, on the other hand, might be able to tolerate 12 items before she loses interest in accomplishing the action items. ML engine can learn this user behavioral trait and impose a proper action item threshold to the second user's task list. Thus, ML engine can monitor user behavior over time and can dynamically modify task lists based on that learned behavior.

One will appreciate how the disclosed principles can be employed in almost any scenario, without limit. As one example, consider a weightlifting scenario in which a user tracks his weightlifting sets and reps. Service 105 can analyze historical data and detect a goal of the user. Here, the goal might be that the user is attempting to achieve one additional rep for every set in each weightlifting session. While the user is lifting weights, service 105 can inform the user of the number of reps performed in the last session and encourage the user to perform at least one additional rep in the current session.

The ML engine can additionally be trained to sort tasks into categories to separate each task list based on a common goal, type of task, or person assigned to the task. For example, the model might flag the task, “buy garbage bags,” as a personal task, while “resolve browser errors,” as a work task. These tasks may then be sorted into separate task lists. Based on the category, the ML engine could then be trained to assign a certain category. For example, if John is typically assigned work tasks, he could be automatically assigned the new task list created for work tasks. The task list may be integrated with other applications. For example, due dates from a list could be synchronized to a calendar, with the option to trigger notifications when a due date is approaching or has been reached.

As shown by the various figures, the disclosed task list is included in a user interface (UI). This UI can define or include any number of visually perceptible UI elements corresponding to action items included in the task list. Optionally, one or more of the visually perceptible UI elements can correspond to an external source, such as perhaps a web page, a payment service, an application, a social media platform, and so on. In some scenarios, one or more of the visually perceptible UI elements include or are an active link associated with those external sources. A user interacting with the UI can provide a signal or user input indicating activation of one or more of the active links (e.g., perhaps a hyperlink). The embodiments can then automatically identify the source corresponding to the link. In response to that identification, the embodiments can automatically retrieve data from the source. Optionally, the data can be displayed in the original UI. As one example, the data may be payment data, and the payment data can be displayed in the original UI. As another option, service 105 can navigate to the source and display the source in a new window.

In some implementations, the embodiments provide a task viewer application to a user. Optionally, the task viewer application can be made available for local installation. Alternatively, the task viewer application can be a cloud-based application or service. In some scenarios, the task viewer application is a plugin component that can be installed or plugged into other, third-party applications. As another alternative, the task viewer application can be provided APIs to communicate with the third-party applications. The embodiments can then receive task information. The embodiments can optionally filter and prioritize the task information by comparing one portion of data to another to determine how they rank against one another in terms of priority. The embodiments can also format the task information into a standardized format. The embodiments can then structure a UI to have a particular layout designed to visually display the formatted task information. When a task is selected within the UI, various activities or operations can be triggered. For instance, tasks can be assigned to responsible parties, notifications can be sent out, calendar scheduling can occur, payment processing can occur, and so on.

The embodiments can also dynamically relocate textual information within the task list, which can be displayed in an underlying window displayed in a graphical user interface. For instance, the embodiments can display a first window comprising the task list, which is structured in accordance with a first format. In response to selection of an action item in the task list and/or in response to selection of a UI element associated with a given action item in the task list, the embodiments can display a second window within the graphical user interface. As one example, this second window may be a payment service. As another example, this second window may include additional metadata associated with the action item, such as perhaps assignment information, deadlines, and so on. The embodiments can constantly monitor the boundaries of the first window and the second window to detect an overlap condition where the second window overlaps the first window such that the task items in the first window may become obscured from a user's view. The embodiments can determine the textual information would not be completely viewable if relocated to an unobstructed portion of the first window. The embodiments may then calculate a first measure of the area of the first window and a second measure of the area of the unobstructed portion of the first window. The embodiments can also calculate a scaling factor that is proportional to the difference between the first measure and the second measure. The embodiments can then scale the textual information based upon the scaling factor. The embodiments can then automatically relocate the scaled textual information to the unobscured portion of the first window in a second format during an overlap condition so that the entire scaled textual information is viewable on the computer screen by the user. Later, the embodiments can automatically return the relocated scaled textual information to the first format within the first window when the overlap condition no longer exists.

Some embodiments are further configured to update a database that records data associated with the various tasks. For instance, some embodiments create a database record for each task included in the task list. Optionally, the database record can include additional information beyond just the text describing the task. As various examples, the database record can include GPS data, image data, video data, audio data, additional text data, and so on. When a task is being operated on, a state of the task, as recorded in the database, can be updated to reflect a “pending” state, or some other indication. When the task is complete, the state can be further updated to reflect a “complete” state, or some other indication. Thus, database records can be created, maintained, and updated for the various tasks in the task list. The database can optionally operate as a historical audit tracking log for the tasks.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

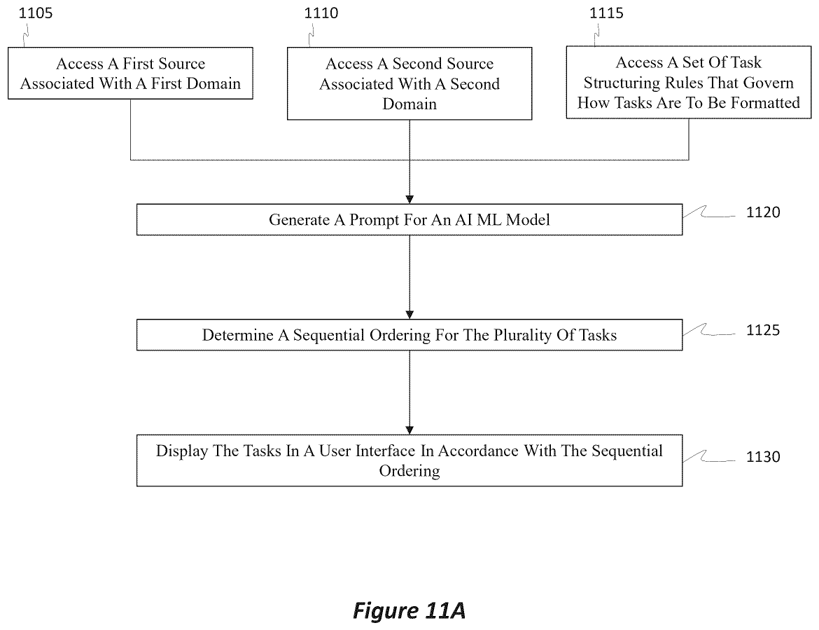

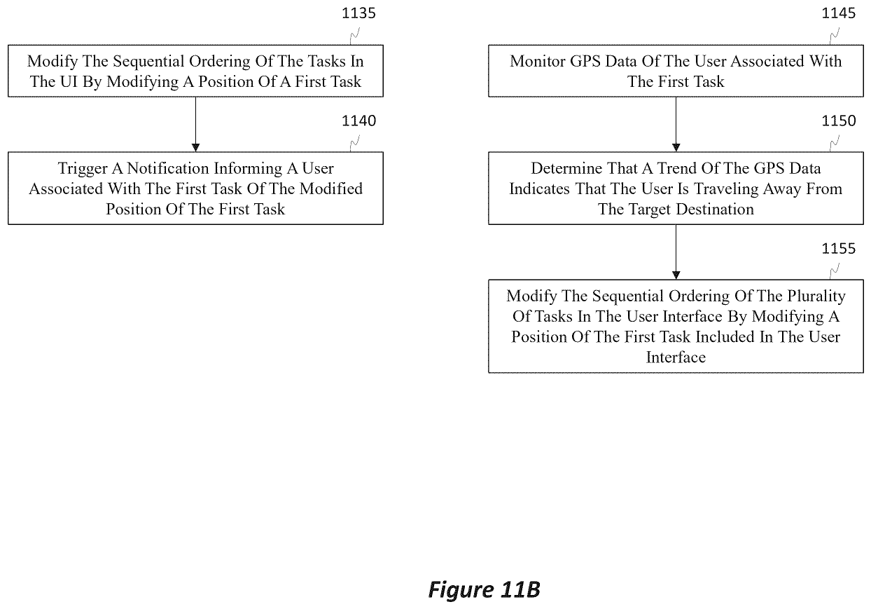

Attention will now be directed to FIG. 11A, which illustrates a flowchart of an example method 1100 for dynamically generating a task list based on data obtained from multiple different sources. Method 1100 can be implemented within the computing architecture 100 of FIG. 1A; further, method 1100 can be implemented by the service 105.

Method 1100 is shown as including an act (act 1105) of accessing a first source associated with a first domain. Notably, the first source includes a set of structured data. As one example, the first domain might be a spreadsheet domain, and the set of structured data might be structured in accordance with a spreadsheet structure or format. Optionally, a plugin component can operate to access and retrieve the set of structured data. For instance, the plugin component might be plugged into the spreadsheet application and can access the underlying data. In some implementations, the ML engine mentioned previously can access the application and can obtain this information.

Act 1110 includes accessing a second source associated with a second domain. The second source includes a set of unstructured data. As one example, the second domain might be a text message domain, and the set of unstructured data might be free-flow text. Similar to the above scenario, the plugin component can obtain this information and/or the machine learning engine can obtain this information. In some implementations, machine learning can be applied to the unstructured data to provide structure to that data. For instance, the machine learning can optionally reformat or reword the text to adhere to a particular target format. In some implementations, the unstructured data can be fed as input to an LLM, and the LLM is able to determine the semantic meaning of the unstructured text. This semantic meaning can then be used to generate new text for inclusion in a subsequent task list.

Act 1115 includes accessing a set of task structuring rules that govern how one or more tasks are to be worded, formatted, or structured. For instance, the task structuring rules can govern the syntax and grammar used in the tasks. Optionally, the task structuring rules are generated by the LLM and/or by the service 105. Optionally, the task structuring rules dictate a grammatical format that is to be used for text describing the one or more tasks.

Act 1120 then includes generating a prompt for a large language model (LLM). The prompt is structured to include the set of structured data, the set of unstructured data (or, optionally, the reformatted data that was generated based on the set of unstructured data), and the set of task structuring rules. The prompt is further structured to include a directive to generate a plurality of tasks worded in accordance with the set of task structuring rules. The generated tasks are ones that reflect any underlying action items that are included in the structured and unstructured text. That is, the plurality of tasks are generated based on the set of structured data 240 and the set of unstructured data 245. Optionally, the LLM might be operating in the architecture 100, such that the architecture 100 and/or the computer system implementing architecture 100 is implementing the LLM. Thus, the computer system can perform these operations.

Act 1125 then includes determining a sequential ordering for the plurality of tasks. In some scenarios, it might be the case that the tasks can be performed in an asynchronous manner relative to one another such that there is no mandated sequential ordering. In other scenarios, it might be the case that one, some, or all of the tasks are to be performed in a specific sequential order. The disclosed embodiments are able to perform this analysis. Optionally, multiple different task lists can be generated based on a determined grouping for the various tasks, where those groups are organized based on common characteristics between the different tasks. Thus, a first task list can be organized in a parallel manner relative to a second task list.

The embodiments are also able to generate metadata for the tasks, such as by generating predicted or projected due dates for the tasks. Often, the due dates are the driving factor for determining the sequential ordering of the tasks. Optionally, assignments to specific individuals can also be predicted and assigned. Optionally, an email, text, or some other notification can be sent to the assigned individual to inform that person of the assignment.

Act 1130 then includes displaying the plurality of tasks in a user interface. These tasks are displayed in the UI in accordance with the sequential ordering. Additionally, the UI can be structured to include other UI fields or elements that are associated with each task item in the task list. For instance, as shown in FIG. 8, a check box UI element can be displayed proximately to a task or action item. Similarly, an avatar or picture of an assigned user can be displayed. Optionally, a UI element for adjusting the position of the task item can be displayed proximately to the task item. Thus, the UI can be configured or structured to include additional UI elements that are usable to reflect a status of the task item. For instance, if the checkbox is checked, it may mean the task has been accomplished whereas if it is not checked, it may mean the task is still pending.

Optionally, a first task included in the plurality of tasks is associated with a target destination. Here, the first task includes GPS data identifying the target destination. In some scenarios, user GPS data reflective of a position of a user associated with the first task is monitored. The embodiments can then determine that the user GPS data indicates the user is within a threshold distance of the target destination and/or a trajectory of the user is trending towards the target distance.

The embodiments can then modify the sequential ordering of the plurality of tasks in the user interface by modifying a position of the first task in the user interface. Optionally, the modified position of the first task in the user interface is a higher position located proximate to or at a topmost task position within the user interface whereas the original position was a lower position that was not located proximate to or at the topmost task position. The embodiments can also trigger a notification informing the user of the modified position of the first task.

Optionally, the embodiments can automatically add the target destination as a new destination in a trip planning GPS application (e.g., perhaps Google Maps). As another option, the set of task structuring rules can be generated by a machine learning (ML) engine. As another option, method 1100 is performed by a service that includes a first plugin component associated with the first domain and a second plugin component associated with the second domain.

In some scenarios, the sequential ordering is modified based on a monitored set of conditions associated with the plurality of tasks, resulting in the plurality of tasks being reorganized within the user interface. Any condition can be monitored.

Method 1100 continues in FIG. 11B. Optionally, method 1100 can include an act (act 1135) of modifying, based on a monitored set of one or more conditions, the sequential ordering of the plurality of tasks in the user interface by modifying a position of a first task included in the user interface. Optionally, the first task can be associated with a target destination, and the first task includes GPS data identifying the target destination. The modified position of the first task in the user interface is a higher position located proximate to or at a topmost task position within the user interface. In some scenarios, the one or more conditions include GPS data, priority data, weight data, user input, and so on.

In some scenarios, user GPS data reflective of a position of the user is monitored. The embodiments can determine that the user GPS data indicates the user is not within a threshold distance of the target destination. The embodiments can then further modify the sequential ordering of the plurality of tasks in the user interface by further modifying the position of the first task in the user interface. Here, the further modified position of the first task in the user interface is a lower position that is not located proximate to or at the topmost task position within the user interface. As another option, the set of task structuring rules can be generated by a large language model (LLM).

Act 1140 then includes triggering a notification informing a user associated with the first task of the modified position of the first task.

In parallel, in serial, as an addition to, or as an alternative to acts 1135 and 1140, act 1145 includes monitoring GPS data of a user associated with the first task. Act 1150 includes determining that a trend of the GPS data indicates that the user is traveling away or is on a trajectory that is trending away from the target destination. Act 1155 then includes modifying the sequential ordering of the plurality of tasks in the user interface by modifying a position of the first task included in the user interface. Here, the modified position of the first task in the user interface is a lower position that is not located proximate to or at the topmost task position within the user interface.

Optionally, the embodiments can add a calendar notice to a calendar application of the user, where the calendar application is hosted by the computer system implementing method 1100. The calendar notice can be associated with a second task included in the plurality of tasks, and the calendar notice can operate as a notification of a deadline associated with the second task. Optionally, the calendar notice can include text describing the second task.

As another option, the embodiments can send a calendar notice to a second calendar application of a second user, where the second calendar application is operating on a second computer system that is different than the computer system implementing method 1100. Here, the calendar notice is sent from a first calendar application of the first or original user. The calendar notice is associated with a second task included in the plurality of tasks, and the calendar notice operates as a notification of a deadline associated with the second task.

In this regard, the disclosed embodiments are beneficially able to intelligently extract action items from any number of sources. Task items can be created to reflect those action items. The tasks can be organized into discrete lists, and the tasks can be assigned to responsible users. By performing the disclosed operations, the embodiments significantly improve how resources are managed and help prevent scenarios in which action items are ignored or missed.

It should be noted how the disclosed principles can be employed in numerous different architectures, scenarios, and environments. As one example, the embodiments can be practiced using a distributed ledger type of database, such as a blockchain, and can be used with a traceable ledger within that blockchain. For instance, the disclosed tasks can be tracked via the blockchain and can be further tracked using the traceable ledger. When a task item is performed to completion, an update can be sent to the blockchain to reflect the completed status of the task item. Additionally, the disclosed tasks can be priced based on current market pricing via the ML engine. In some scenarios, the disclosed ML engine can estimate prices and can also estimate time date for the tasks (e.g., perhaps an average completion time for the tasks).

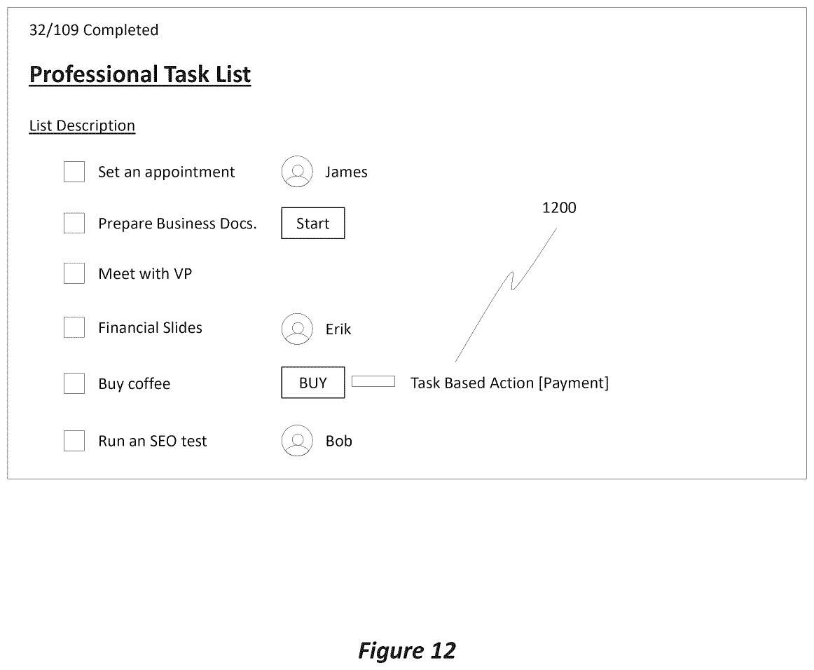

Also, in some implementations, a user can, using the disclosed user interfaces, facilitate the processing of a payment directly from a task to pay a delivery service or some other service. For example, FIG. 12 shows an example scenario involving a task list. This task list includes a line item of “Buy coffee.” Proximate to that line item is an action 1200. The user can interact directly with the action 1200 within the task list to facilitate a payment for the corresponding task. It may be the case that the user previously linked or connected a payment API to the task list, such as by using the user interface shown in FIG. 1B. Service 105 can use this connected API to facilitate payments.

For instance, in FIG. 12, the user can select the user interface element next to “Buy coffee,” and the selection of that element will trigger the use of a third-party service, via the connected API, to pay for the task. As another example, consider a scenario where the task list is to buy a certain item from an online shopping forum. The task list can identify the specific item. The task list can be further configured to display an option next to the task, where the option enables a user to trigger the payment for the item from within the task list. In some scenarios, the embodiments (as a background process) navigate to the online shopping forum, identify the specific item, and then automatically trigger the purchase of that item. A reporting notification can then be displayed within the task list. For instance, a green checkmark can be displayed to indicate that the item was successfully purchased. Additionally, or alternatively, a window can be displayed listing the purchase details (e.g., purchase timestamp, payment price, etc.). Accordingly, some embodiments are configured to enable the purchase of an item or service from within the task list.

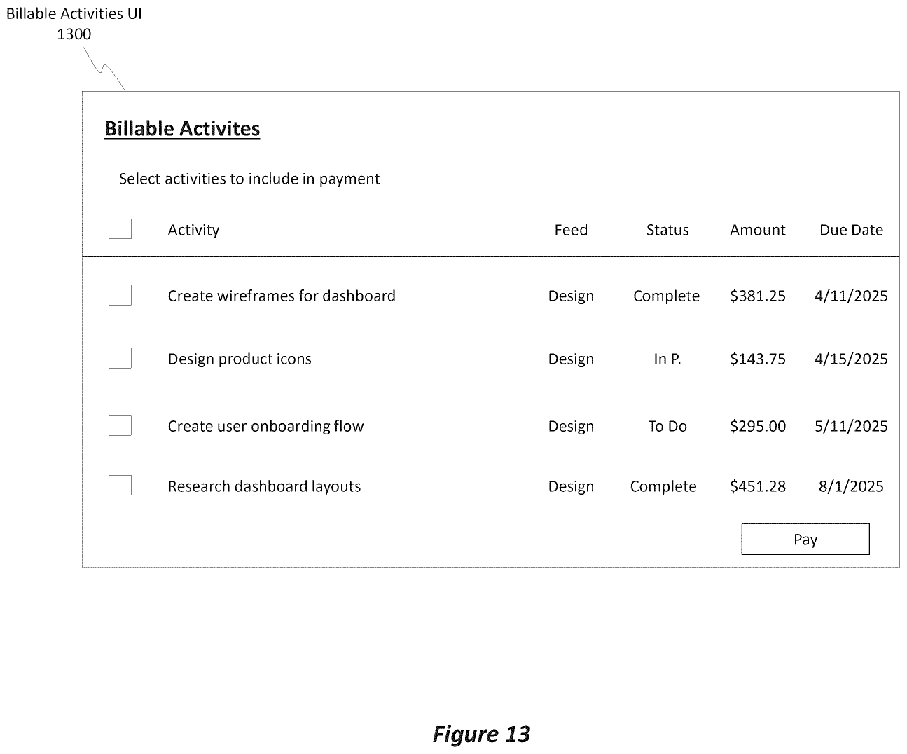

FIG. 13 shows an example of a billable activities UI 1300. Whereas the above example focused on a scenario where an item was purchased using the payment service and API, the billable activities UI 1300 shows a scenario where services, agents, or human users can be paid. For instance, one of the task items in the list shown in FIG. 13 is the following task: “Create wireframes for dashboard.” This task has a due date of Apr. 11, 2025 and a cost of $381.25. A user can select that task and then select the “Pay” option, which will trigger the payment service and result in the user who completed the task receiving payment for that user's efforts. Thus, payments can be facilitated through the disclosed principles and UIs.

### Example Computer/Computer Systems

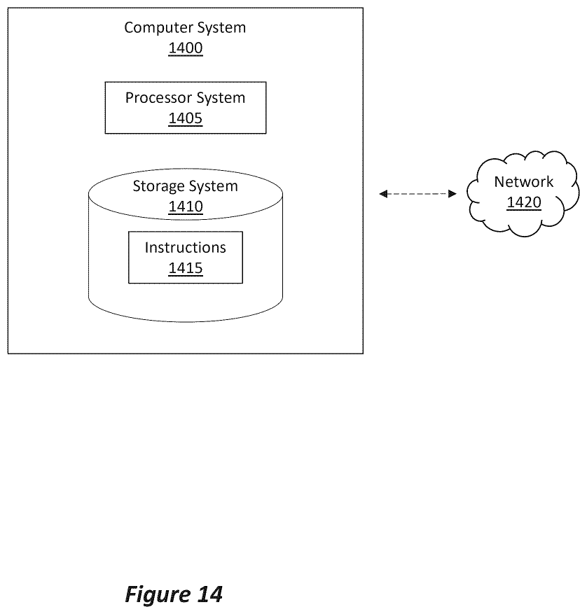

Attention will now be directed to FIG. 14 which illustrates an example computer system 1400 that may include and/or be used to perform any of the operations described herein. For instance, computer system 1400 can operate within architecture 100 of FIG. 1A and can implement service 105. As such, computer system 1400 can perform method 1100 of FIG. 11A.

Computer system 1400 may take various different forms. For example, computer system 1400 may be embodied as a tablet, a desktop, a laptop, a mobile device, or a standalone device, such as those described throughout this disclosure. Computer system 1400 may also be a distributed system that includes one or more connected computing components/devices that are in communication with computer system 1400.

In its most basic configuration, computer system 1400 includes various different components. FIG. 14 shows that computer system 1400 includes a processor system 1405 that includes one or more processor(s) (aka a “hardware processing unit”) and a storage system 1410.

Regarding the processor(s), it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 1400. The different components, modules, engines, and services described herein may be implemented as objects or processors that execute on computer system 1400 (e.g. as separate threads).

Storage system 1410 may be physical system memory, which may be volatile, non-volatile, or some combination of the two. The term “memory” may also be used herein to refer to non-volatile mass storage such as physical storage media. If computer system 1400 is distributed, the processing, memory, and/or storage capability may be distributed as well.

Storage system 1410 is shown as including executable instructions 1415. The executable instructions 1415 represent instructions that are executable by the processor(s) the processor system 1405 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1400 may also be connected (via a wired or wireless connection) to external sensors (e.g., one or more remote cameras) or devices via a network 1420. For example, computer system 1400 can communicate with any number devices or cloud services to obtain or process data. In some cases, network 1420 may itself be a cloud network. Furthermore, computer system 1400 may also be connected through one or more wired or wireless networks to remote/separate computer systems(s) that are configured to perform any of the processing described with regard to computer system 1400.

A “network,” like network 1420, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1400 will include one or more communication channels that are used to communicate with the network 1420.

Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The disclosed embodiments can be implemented in numerous different ways, as described in the various different clauses recited below.

Clause 1. A method comprising: accessing a first source associated with a first domain, wherein the first source includes a set of structured data; accessing a second source associated with a second domain, wherein the second source includes a set of unstructured data; accessing a set of task structuring rules that govern how one or more tasks are to be formatted; generating a prompt for a machine learning (ML) predictive model, the prompt including the set of structured data, the set of unstructured data, and the set of task structuring rules, wherein the prompt further includes a directive to generate a plurality of tasks worded in accordance with the set of task structuring rules, where the plurality of tasks is generated based on the set of structured data and the set of unstructured data; in response to the ML predictive model generating the plurality of tasks, determining a sequential ordering for the plurality of tasks; and displaying the plurality of tasks in a user interface in accordance with the sequential ordering.

Clause 2. The method of any of the preceding clauses, wherein the first domain is a spreadsheet domain.

Clause 3. The method of any of the preceding clauses, wherein the second domain is a text message domain.

Clause 4. The method of any of the preceding clauses, wherein the task structuring rules dictate a grammatical format that is to be used for text describing the one or more tasks.

Clause 5. The method of any of the preceding clauses, wherein a first task included in the plurality of tasks is associated with a target destination, and wherein the first task includes global positioning system (GPS) data identifying the target destination.

Clause 6. The method of any of the preceding clauses, wherein user GPS data reflective of a position of a user associated with the first task is monitored, and wherein the method further includes: determining that the user GPS data indicates the user is within a threshold distance of the target destination; modifying the sequential ordering of the plurality of tasks in the user interface by modifying a position of the first task in the user interface, wherein the modified position of the first task in the user interface is a higher position located proximate to or at a topmost task position within the user interface; and triggering a notification informing the user of the modified position of the first task.

Clause 7. The method of any of the preceding clauses, wherein the method further includes automatically adding the target destination as a new destination in a trip planning GPS application.

Clause 8. The method of any of the preceding clauses, wherein the set of task structuring rules is generated by a machine learning (ML) engine.

Clause 9. The method of any of the preceding clauses, wherein said method is performed by a service that includes a first plugin component associated with the first domain and a second plugin component associated with the second domain.

Clause 10. The method of any of the preceding clauses, wherein the sequential ordering is modified based on a monitored set of conditions associated with the plurality of tasks, resulting in the plurality of tasks being reorganized within the user interface.

Clause 11. A computer system comprising: a processor system; and a storage system that stores instructions that are executable by the processor system to cause the computer system to: access a first source associated with a first domain, wherein the first source includes a set of structured data; access a second source associated with a second domain, wherein the second source includes a set of unstructured data; access a set of task structuring rules that govern how one or more tasks are to be formatted; generate a prompt for a machine learning (ML) predictive model, the prompt including the set of structured data, the set of unstructured data, and the set of task structuring rules, wherein the prompt further includes a directive to generate a plurality of tasks worded in accordance with the set of task structuring rules, where the plurality of tasks is generated based on the set of structured data and the set of unstructured data; in response to the ML predictive model generating the plurality of tasks, determine a sequential ordering for the plurality of tasks; display the plurality of tasks in a user interface in accordance with the sequential ordering; modify, based on a monitored set of one or more conditions, the sequential ordering of the plurality of tasks in the user interface by modifying a position of a first task included in the user interface, wherein the modified position of the first task in the user interface is a higher position located proximate to or at a topmost task position within the user interface; and trigger a notification informing a user associated with the first task of the modified position of the first task.

Clause 12. The computer system of clause 11, wherein the first domain is a spreadsheet domain, and wherein the second domain is a text message domain.

Clause 13. The computer system of any of the preceding clauses, wherein the task structuring rules dictate a grammatical format that is to be used for text describing the one or more tasks.

Clause 14. The computer system of any of the preceding clauses, wherein the first task is associated with a target destination, and wherein the first task includes global positioning system (GPS) data identifying the target destination.

Clause 15. The computer system of any of the preceding clauses, wherein user GPS data reflective of a position of the user is monitored, and wherein the instructions are further executable to cause the computer system to: determine that the user GPS data indicates the user is not within a threshold distance of the target destination; and further modify the sequential ordering of the plurality of tasks in the user interface by further modifying the position of the first task in the user interface, wherein the further modified position of the first task in the user interface is a lower position that is not located proximate to or at the topmost task position within the user interface.

Clause 16. The computer system of any of the preceding clauses, wherein the set of task structuring rules is generated by a large language model (LLM).

Clause 17. A computer system comprising: a processor system; and a storage system that stores instructions that are executable by the processor system to cause the computer system to: access a first source associated with a first domain, wherein the first source includes a set of structured data; access a second source associated with a second domain, wherein the second source includes a set of unstructured data; access a set of task structuring rules that govern how one or more tasks are to be formatted; generate a prompt for a machine learning (ML) predictive model, the prompt including the set of structured data, the set of unstructured data, and the set of task structuring rules, wherein the prompt further includes a directive to generate a plurality of tasks worded in accordance with the set of task structuring rules, where the plurality of tasks is generated based on the set of structured data and the set of unstructured data; in response to the ML predictive model generating the plurality of tasks, determine a sequential ordering for the plurality of tasks; display the plurality of tasks in a user interface in accordance with the sequential ordering, wherein a first task included in the plurality of tasks is located proximate to or at a topmost task position within the user interface, wherein the first task is associated with a target destination; monitor global positioning system (GPS) data of a user associated with the first task; determine that a trend of the GPS data indicates that the user is traveling away from the target destination; and modify the sequential ordering of the plurality of tasks in the user interface by modifying a position of the first task included in the user interface, wherein the modified position of the first task in the user interface is a lower position that is not located proximate to or at the topmost task position within the user interface.

Clause 18. The computer system of any of the preceding clauses, wherein the instructions are further executable to cause the computer system to: add a calendar notice to a calendar application of the user, wherein the calendar application is hosted by the computer system, wherein the calendar notice is associated with a second task included in the plurality of tasks, and wherein the calendar notice operates as a notification of a deadline associated with the second task.

Clause 19. The computer system of any of the preceding clauses, wherein the calendar notice includes text describing the second task.

Clause 20. The computer system of any of the preceding clauses, wherein the instructions are further executable to cause the computer system to: send a calendar notice to a second calendar application of a second user, wherein the second calendar application is operating on a second computer system that is different than said computer system, wherein the calendar notice is sent from a first calendar application of said user, wherein the calendar notice is associated with a second task included in the plurality of tasks, and wherein the calendar notice operates as a notification of a deadline associated with the second task.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
accessing a first source associated with a first domain, wherein the first source includes a set of structured data;
accessing a second source associated with a second domain, wherein the second source includes a set of unstructured data;
accessing a set of task structuring rules that govern how one or more tasks are to be formatted;
generating a prompt for a machine learning (ML) predictive model, the prompt including the set of structured data, the set of unstructured data, and the set of task structuring rules, wherein the prompt further includes a directive to generate a plurality of tasks worded in accordance with the set of task structuring rules, and wherein the plurality of tasks is generated based on the set of structured data and the set of unstructured data;
in response to the ML predictive model generating the plurality of tasks, determining a sequential ordering for the plurality of tasks; and
displaying the plurality of tasks in a user interface in accordance with the sequential ordering.

2. The method of claim 1, wherein the first domain is a spreadsheet domain.

3. The method of claim 1, wherein the second domain is a text message domain.

4. The method of claim 1, wherein the task structuring rules dictate a grammatical format that is to be used for text describing the one or more tasks.

5. The method of claim 1, wherein a first task included in the plurality of tasks is associated with a target destination, and wherein the first task includes global positioning system (GPS) data identifying the target destination.

6. The method of claim 5, wherein user GPS data reflective of a position of a user associated with the first task is monitored, and wherein the method further includes:
determining that the user GPS data indicates the user is within a threshold distance of the target destination;
modifying the sequential ordering of the plurality of tasks in the user interface by modifying a position of the first task in the user interface, wherein the modified position of the first task in the user interface is a higher position located proximate to or at a topmost task position within the user interface; and
triggering a notification informing the user of the modified position of the first task.

7. The method of claim 6, wherein the method further includes automatically adding the target destination as a new destination in a trip planning GPS application.

8. The method of claim 1, wherein the set of task structuring rules is generated by a machine learning (ML) engine.

9. The method of claim 1, wherein said method is performed by a service that includes a first plugin component associated with the first domain and a second plugin component associated with the second domain.

10. The method of claim 1, wherein the sequential ordering is modified based on a monitored set of conditions associated with the plurality of tasks, resulting in the plurality of tasks being reorganized within the user interface.

11. A computer system comprising:
a processor system; and
a storage system that stores instructions that are executable by the processor system to cause the computer system to:
access a first source associated with a first domain, wherein the first source includes a set of structured data;
access a second source associated with a second domain, wherein the second source includes a set of unstructured data;
access a set of task structuring rules that govern how one or more tasks are to be formatted;
generate a prompt for a machine learning (ML) predictive model, the prompt including the set of structured data, the set of unstructured data, and the set of task structuring rules, wherein the prompt further includes a directive to generate a plurality of tasks worded in accordance with the set of task structuring rules, where the plurality of tasks is generated based on the set of structured data and the set of unstructured data;
in response to the ML predictive model generating the plurality of tasks, determine a sequential ordering for the plurality of tasks;
display the plurality of tasks in a user interface in accordance with the sequential ordering;
modify, based on a monitored set of one or more conditions, the sequential ordering of the plurality of tasks in the user interface by modifying a position of a first task included in the user interface, wherein the modified position of the first task in the user interface is a higher position located proximate to or at a topmost task position within the user interface; and
trigger a notification informing a user associated with the first task of the modified position of the first task.

12. The computer system of claim 11, wherein the first domain is a spreadsheet domain, and wherein the second domain is a text message domain.

13. The computer system of claim 11, wherein the task structuring rules dictate a grammatical format that is to be used for text describing the one or more tasks.

14. The computer system of claim 11, wherein the first task is associated with a target destination, and wherein the first task includes global positioning system (GPS) data identifying the target destination.

15. The computer system of claim 14, wherein user GPS data reflective of a position of the user is monitored, and wherein the instructions are further executable to cause the computer system to:
determine that the user GPS data indicates the user is not within a threshold distance of the target destination; and
further modify the sequential ordering of the plurality of tasks in the user interface by further modifying the position of the first task in the user interface, wherein the further modified position of the first task in the user interface is a lower position that is not located proximate to or at the topmost task position within the user interface.

16. The computer system of claim 11, wherein the set of task structuring rules is generated by a large language model (LLM).

17. A computer system comprising:
a processor system; and
a storage system that stores instructions that are executable by the processor system to cause the computer system to:
access a first source associated with a first domain, wherein the first source includes a set of structured data;
access a second source associated with a second domain, wherein the second source includes a set of unstructured data;
access a set of task structuring rules that govern how one or more tasks are to be formatted;
generate a prompt for a machine learning (ML) predictive model, the prompt including the set of structured data, the set of unstructured data, and the set of task structuring rules, wherein the prompt further includes a directive to generate a plurality of tasks worded in accordance with the set of task structuring rules, where the plurality of tasks is generated based on the set of structured data and the set of unstructured data;
in response to the ML predictive model generating the plurality of tasks, determine a sequential ordering for the plurality of tasks;
display the plurality of tasks in a user interface in accordance with the sequential ordering, wherein a first task included in the plurality of tasks is located proximate to or at a topmost task position within the user interface, and wherein the first task is associated with a target destination;
monitor global positioning system (GPS) data of a user associated with the first task;
determine that a trend of the GPS data indicates that the user is traveling away from the target destination; and
modify the sequential ordering of the plurality of tasks in the user interface by modifying a position of the first task included in the user interface, wherein the modified position of the first task in the user interface is a lower position that is not located proximate to or at the topmost task position within the user interface.

18. The computer system of claim 17, wherein the instructions are further executable to cause the computer system to:
add a calendar notice to a calendar application of the user, wherein the calendar application is hosted by the computer system, wherein the calendar notice is associated with a second task included in the plurality of tasks, and wherein the calendar notice operates as a notification of a deadline associated with the second task.

19. The computer system of claim 18, wherein the calendar notice includes text describing the second task.

20. The computer system of claim 17, wherein the instructions are further executable to cause the computer system to:
send a calendar notice to a second calendar application of a second user, wherein the second calendar application is operating on a second computer system that is different than said computer system, wherein the calendar notice is sent from a first calendar application of said user, wherein the calendar notice is associated with a second task included in the plurality of tasks, and wherein the calendar notice operates as a notification of a deadline associated with the second task.
